(19) United States
(12) Patent Application Publication
(10) Pub. No.: US 2026/0019795 A1
(43) Pub. Date: Jan. 15, 2026

(54) SYSTEMS AND METHODS FOR OPTIMIZING NETWORK FUNCTION SELECTION FOR ROAMING

(71) Applicant: Verizon Patent and Licensing Inc., Basking Ridge, NJ (US)

(72) Inventors: Jerry Steben, Fort Worth, TX (US); Violeta Cakulev, Millburn, NJ (US); Sudhakar Reddy Patil, Flower Mound, TX (US); Ce Xu, Campbell, CA (US)

(21) Appl. No.: 18/769,653

(22) Filed: Jul. 11, 2024

(51) Int. Cl. H04W 8/08; H04W 8/04; H04W 84/04

(52) U.S. Cl. CPC H04W 8/08; H04W 8/04; H04W 84/042

(57) ABSTRACT

A method, a device, and a non-transitory storage medium provide an optimized network function (NF) selection service for roaming. A first network device in a home network receives, from a second network device, a first discovery message, the first discovery message including a visited network identifier for a roaming session. The first network device matches the visited network identifier to a network identifier in a Session Management Function (SMF) profile. The first network device sends, to the second network device, a first identifier for a home SMF for the roaming session based on the visited network identifier.

### BACKGROUND INFORMATION

Public Land Mobile Networks (PLMNs) are traditionally designed to support mobile devices over an extensive geographic area (e.g., national or regional coverage). When a subscriber with one PLMN operator (e.g., a “home” PLMN) is unable to connect for service, another PLMN operator (e.g., a “visited” PLMN) may provide roaming services, based on an agreement between the PLMN operators. The Fifth Generation Systems (5GS) roaming architecture enables operators to expand their existing roaming agreements and networks to incorporate 5GS. Defined roaming architectures for PLMNs include Home Routed (HR) architecture and Local Breakout (LBO) architecture.

### BRIEF DESCRIPTION OF THE DRAWINGS

FIG. 1 provides an example of an environment in which an optimized network function (NF) selection service for roaming may be implemented;

FIG. 2 is a diagram illustrating network device registration to support the optimized NF selection service for roaming, according to an implementation;

FIGS. 3A and 3B are tables illustrating profile attributes to support the optimized NF selection service for roaming;

FIG. 4 is a diagram illustrating exemplary communications for the optimized NF selection service for roaming, according to an implementation;

FIGS. 5A and 5B are tables illustrating attributes of response parameters to support the optimized NF selection service for roaming;

FIGS. 6 and 7 are flow charts of example operations for the optimized NF selection service for roaming, according to an implementation;

FIG. 8 is a diagram illustrating exemplary components of a device that may correspond to one or more of the devices illustrated herein; and

FIG. 9 illustrates a use case for the optimized NF selection service for roaming.

### DETAILED DESCRIPTION

The following detailed description refers to the accompanying drawings. The same reference numbers in different drawings may identify the same or similar elements. Also, the following detailed description does not limit the invention.

Systems and methods described herein provide enhancements for Home Routed (HR) architectures in Fifth Generation Systems (5GS). In HR architecture, when a subscriber is roaming in a visited network, data plane traffic is directed to the subscriber's Home Public Land Mobile Network (H-PLMN). The H-PLMN then processes and forwards the data traffic to its ultimate destination. The HR approach allows the H-PLMN to control and monitor data traffic against the subscriber's activity from the Visited PLMN (V-PLMN). Local Breakout (LBO) architecture enables the V-PLMN to grant end-users direct access to external networks through its local User Plane Function (UPF), bypassing routing through the H-PLMN. The LBO approach significantly reduces latency in data traffic, as it eliminates the extra round-trip time required for routing data through the H-PLMN. However, the LBO approach raises concerns about reliability from the H-PLMN's perspective, as the H-PLMN loses visibility into and control over the data plane for evaluating and accounting the subscriber's usage in the visited network. Therefore, HR architecture is the predominant roaming approach for 4G or Long Term Evolution (LTE) networks and is also considered a primary choice for 5G Standalone (SA) roaming.

In HR architecture, it may be beneficial to dedicate Session Management Functions (SMFs) and/or UPFs specifically for roaming traffic as roaming services may introduce roaming specific functionality, such as a need for increased security, controlled resource allocation, etc. Moreover, there may be a need to dedicate an SMF/UPF based on the PLMN, such that different SMFs/UPFs are dedicated to different PLMNs based, for example, on geographical location, latency, etc. Current standards allow an SMF to be selected based on whether roaming functionality is supported by an SMF (i.e., visited SMF (V-SMF) functionality) and UPF (i.e., an N9 interface). However, there is currently no standardized mechanism to select an SMF/UPF for a specific PLMN.

According to implementations described herein, SMF and UPF profiles that are registered with a Network Repository Function (NRF) may be enhanced to include information regarding whether specific PLMNs are supported. Parameters for queries to the NRF may also be modified such that a Network Function (NF) consumer can indicate when a PLMN-specific SMF and UPF need to be discovered or identified.

Also, in some aspects of HR architecture, it may be beneficial to provide the H-PLMN with sufficient information to select the topologically (or geographically) closest home UPF (H-UPF) for a roaming session. 5GS architecture provides three Session and Service Continuity (SSC) modes. In SCC mode 1, a Protocol Data Unit (PDU) session anchor UPF is maintained throughout session lifetime regardless of UE mobility. SSC modes 2 and 3 have provisions for UPF reselection. Thus, selection of the topologically (or geographically) closest UPF is applicable to SSC mode 1 only. As used herein, “topologically closest” or “geographically closest” may be considered the H-UPF that is physically the closest to the serving internetwork packet exchange (IPX), thus reducing latency to the subscriber while in the V-PLMN as best as possible.

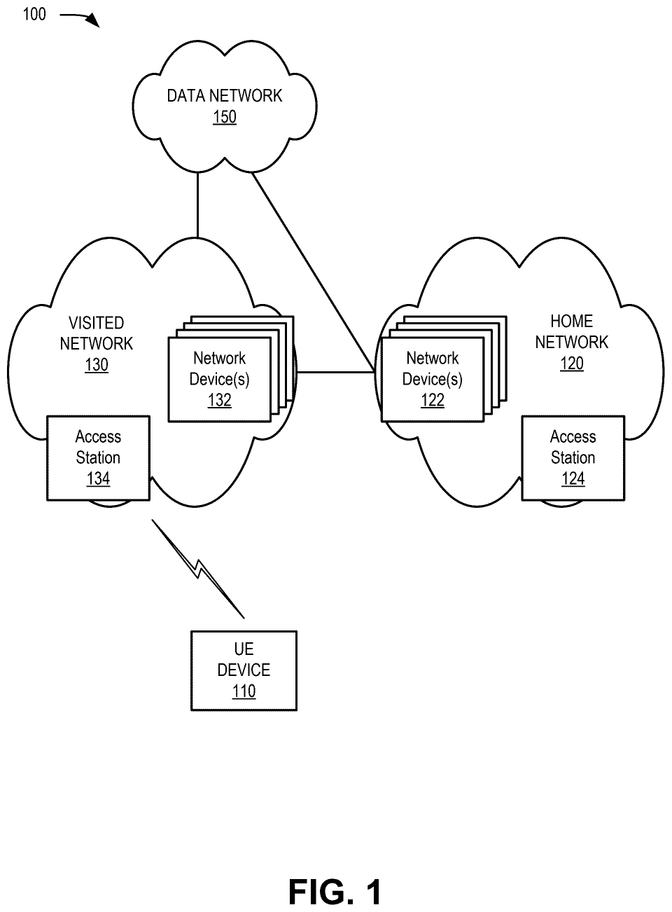

FIG. 1 provides an overview of a network environment 100 in which an optimized NF selection service for roaming may be implemented. As shown, network environment 100 may include a UE device 110, a home network 120, a visited network 130, and a data network 150.

UE device 110 may include a wireless communication device. Examples of UE device 110 include a cellular telephone device (e.g., a conventional cell phone with data processing capabilities), a smart phone, a personal digital assistant (PDA) that can include a radiotelephone, a wearable computer (e.g., a smart watch), a vehicle telematics system, an Internet-of-Things (IoT) device, etc. UE device 110 may store, for example, a home network identifier (ID) (e.g., a PLMN ID) or other indicator that identifies the home network of a subscriber.

Home network 120 may include a network of a wireless carrier that is associated with UE device 110 via a subscription. Home network 120 may be a default/primary network for providing service to UE device 110. Home network 120 may include, for example, a radio access network (RAN), a core network, and other networks. For example, home network 120 may include a local area network (LAN), a wireless LAN, a wide area network (WAN), a metropolitan area network (MAN), an optical network, a cable television network, a satellite network, a wireless network (e.g., a Code Division Multiple Access (CDMA) network, a general packet radio service (GPRS) network, a Long Term Evolution (LTE) network (e.g., 4G network), a 5G network, a Sixth Generation (6G) or future network, an ad hoc network, a telephone network (e.g., the Public Switched Telephone Network (PSTN) or a cellular network), an intranet, or a combination of networks. Home network 120 may allow the delivery of Internet Protocol (IP) services to UE device 110 and may interface with and/or include other networks, such as data network 150.

Depending on the implementation, home network 120 may include one or multiple types of network devices 122. For example, network devices 122 may include RAN devices, such as a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a distributed unit (DU), a small cell node (e.g., a picocell device, a femtocell device, a microcell device, a home eNB, a home gNB, etc.), a 5G ultra-wide band (UWB) node, a future generation wireless access device (e.g., a 6G wireless station or another generation of wireless station). In the illustration of FIG. 1, an access station 124, which may include one of network devices 122, may establish a wireless connection with UE device 110 to home network 120.

In other implementations, network devices 122 may include core network devices, such as a UPF, a session management function (SMF), an access and mobility management function (AMF), a network repository function (NRF), a unified data management (UDM) device, a unified data repository (UDR), an application function (AF), an authentication server function (AUSF), a security anchor function (SEAF), a network slice selection function (NSSF), a network data analytics function (NWDAF), a policy control function (PCF), a network exposure function (NEF), or a service capability exposure function (SCEF). According to other implementations, network devices 122 may include additional, different, and/or fewer network devices than those described. For example, network device 122 may include a gateway, a router, a switch, a firewall, a bridge, a proxy server, a server, or some other type of device that processes and/or transfers data.

Visited network 130 may include a network of a wireless carrier that is not a home network for UE device 110 (e.g., a network that is not registered as a primary network for UE device 110) and/or a network to which UE device 110 does not subscribe. For example, visited network 130 may be associated with a wireless carrier that supports a roaming agreement for UE device 110 or that otherwise may be able to support network services and/or application services when home network 120 is not available to UE device 110. Visited network 130 may generally include features similar to those of home network 120 and have network devices 132 similar to those described above for home network 120 and network devices 122. However, as a visited network, some services and other system capabilities of a home network are not typically available to a visiting UE device 110. In the illustration of FIG. 1, an access station 134, which may include one of network devices 132, may establish a wireless connection with a UE device 110 to visited network 130, when UE device 110 cannot access home network 120.

Data network 150 may include, for example, a packet data network. In an implementation, UE device 110 may connect to data network 150 via home network 120 and, when roaming, visited network 130. Data network 150 may also include and/or be connected to a LAN, WAN, MAN, an autonomous system (AS) on the Internet, an optical network, a cable television network, a satellite network, a wireless network, an ad hoc network, a telephone network (e.g., the PSTN or a cellular network), an intranet, or a combination of networks.

The number of devices, the number of networks, and the configuration in environment 100 are exemplary. According to other embodiments, environment 100 may include additional devices, fewer devices, and/or differently arranged devices, than those illustrated in FIG. 1. For example, according to other embodiments, environment 100 may include additional wired and/or wireless networks.

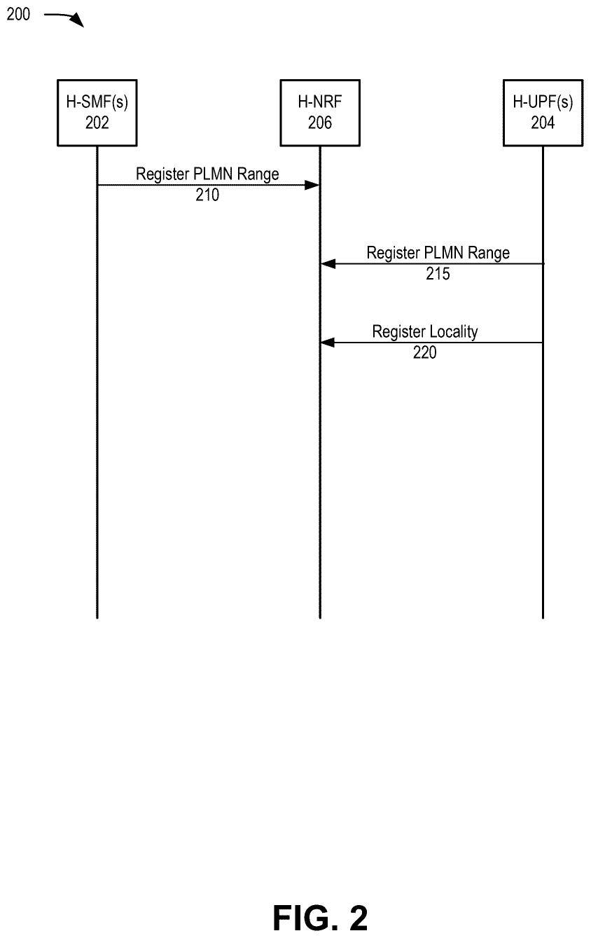

FIG. 2 is a diagram of a portion 200 of network environment 100 including components of network 120 for an optimized NF selection service for roaming, according to an implementation. As shown in FIG. 2, network portion 200 may include a home SMF (H-SMF) 202, a home UPF (H-UPF) 204, and a home NRF (H-NRF) 206. Although H-SMF 202, H-UPF 204, and H-NRF 206 are described in FIG. 2 as “home” NFs for purposes of discussion, it should be understood that functions of these NFs may also support visited and non-roaming scenarios. Communications in FIG. 2, illustrate communications to register network functions with an NRF prior to a roaming scenario. FIG. 2 provides simplified illustrations of communications in network portion 200 and is not intended to reflect every signal or communication exchanged between devices/functions.

H-SMF 202, H-UPF 204, and/or H-NRF 206 may each provide a function and/or a service in accordance with a network standard, such as Third Generation Partnership Project (3GPP), 3GPP2, International Telecommunication Union (ITU), European Telecommunications Standards Institute (ETSI), GSM Association (GSMA), or the like and/or of a proprietary nature. According to an exemplary embodiment, H-SMF 202, H-UPF 204, and H-NRF 206 may each include logic of an aspect of the optimized NF selection service and/or provide support for a process of the optimized NF selection service. For example, H-SMF 202, H-UPF 204, and/or H-NRF 206 may each perform a function, an operation, and/or a service that is beyond a function and/or service associated with the network standard.

H-SMF 202 may be a network element that is capable of performing session establishment, session modification, and/or session release, perform IP address allocation and management, perform Dynamic Host Configuration Protocol (DHCP) functions, perform selection and control of UPF 204, configure traffic steering at UPF 204 to guide the traffic to the correct destinations, perform lawful intercepts, control and coordinate charging data collection, terminate session management parts of Non-Access Stratum (NAS) messages, perform downlink data notification, and/or perform other types of control plane processes for managing user plane data. According to implementations described herein, H-SMF 202 may be configured to support roaming services from one or more designated V-PLMNs (e.g., visited network 130).

H-UPF 204 may be a network function that is capable of maintaining an anchor point for mobility, maintain an external PDU point of interconnect to a particular data network 150, perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, and/or perform other types of user plane processes. According to implementations described herein, H-SMF 202 may be configured to support roaming services from one or more designated V-PLMNs (e.g., visited network 130) and/or designated based on locality to a current Security Edge Protection Proxy (SEPP) for a roaming session.

H-NRF 206 operates as a centralized repository of information regarding NFs in home network 120. H-NRF 206 enables NFs (e.g., SMF 202, UPF 204, etc.) to register and discover each other via an Application Programming interface (API). NRF 206 maintains an updated repository of information about the NFs available in home network 120, along with information about the services provided by each of the NFs. NRF 206 further enables the NFs to obtain updated status information of other NFs in home network 120. NRF 206 may, for example, maintain profiles of available NF instances and their supported services, allow NF instances to discover other NF instances in home network 120, and allow NF instances to track the status of other NF instances. According to implementations described herein, H-NRF 206 may be configured to store and query parameters to enable designation of specific SMFs 202 and/or UPFs 204 for different V-PLMNs (e.g., visited network 130).

As indicated at signal 210, each H-SMF 202 may register with H-NRF 206 to provide PLNM restrictions, such as a list of PLMNs that can be served by the H-SMF 202 during roaming. According to an implementation, the PLMN restrictions may be included with SMF information in an SMF profile. For example, a new attribute within an SMFinfo data type may include the PLMN restrictions.

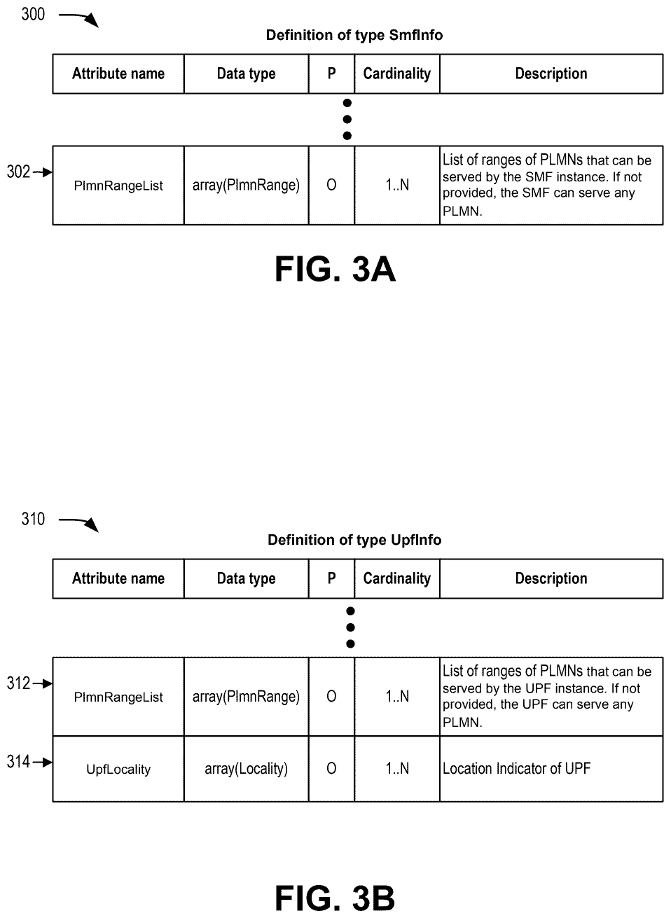

FIG. 3A is a diagram illustrating parameters of a new attribute, PlmnRangeList 302, for an SMFinfo data type 300, which may be used in signal 210 described above. According to an implementation, the parameters for SMFinfo data type 300 may be defined in a structured data type according to a format for wireless network standards, such as a 3GPP standard, or another schema. SMFinfo data type 300 may include a list of attributes, with each attribute including an attribute name, a data type, a presence (P) indicator, a cardinality indicator, and a description. The presence indicator may indicate mandatory (“M”) or optional (“O”) inclusion of an attribute, while the cardinality indicator may indicate the number of characteristics for the attribute.

According to implementations described herein, a new attribute, PlmnRangeList attribute 302, may be added to a set of previously-known attributes for the SMFinfo data type 300. PlmnRangeList attribute 302 may define attributes for a what PLMN(s) may be serviced by a particular H-SMF 202. For example, PlmnRangeList attribute 302 may define a single PLMN or a group of PLMNs to which roaming service can be provided by the H-SMF 202. In one implementation, if PlmnRangeList attribute 302 is not included in SMFinfo data type 300 (or if no PLMNs are listed in PlmnRangeList attribute 302), H-SMF 202 may serve any PLMN.

The form of an attribute data type that may be used for SMFinfo data type 300 illustrated in FIG. 3A is exemplary. The number of attributes, the range of values, and the representation of each attribute may differ in other implementations.

Returning to FIG. 2, as indicated at reference 215, each H-UPF 204 may register with H-NRF 206 to provide PLNM restrictions, such as a list of PLMNs that can be served by the H-UPF 204 during roaming. According to an implementation, the PLMN restrictions may be included with UPF information in a UPF profile. For example, a new attribute within a UPFinfo data type may include the PLMN restrictions.

As indicated at reference 220, each H-UPF 204 may register with H-NRF 206 to provide locality data, such as a city, state, region, or another geographic area of the H-UPF 204. In other implementations, the locality data may include a set of coordinates or defined section within a grid. According to an implementation, the locality data may be included with UPF information in the UPF profile. For example, a new attribute within a UPFinfo data type may include the locality data.

FIG. 3B is a diagram illustrating parameters of a PlmnRangeList attribute 312 and a locality data attribute 314 for a UPFinfo data type 310, which may be used in signals 210 and 220 described above. According to an implementation, the parameters for UPFinfo data type 310 may be defined in a structured data type according to a format for wireless network standards, such as a 3GPP standard, or another schema. Similar to SMFinfo data type 300, UPFinfo data type 310 may include a list of attributes, with each attribute including an attribute name, a data type, a presence indicator, a cardinality indicator, and a description. According to implementations described herein, a new attribute, PlmnRangeList attribute 312, may be added to a set of previously-known attributes for the UPFinfo data type 310. PlmnRangeList attribute 312 may define attributes for what PLMN(s) may be serviced by a particular H-UPF 204. For example, PlmnRangeList attribute 312 may define a single PLMN or a group of PLMNs to which roaming service can be provided by the H-UPF 204. In one implementation, if PlmnRangeList attribute 312 is not included in UPFinfo data type 310 (or if no PLMNs are listed in attribute PlmnRangeList attribute 312), H-UPF 204 may serve any PLMN.

As further shown in FIG. 3B, another new attribute, UpfLocality attribute 314, may be added to a set of previously-known attributes for the UPFinfo data type 310. UpfLocality attribute 314 may define a serving location for a particular H-UPF 204. For example, UpfLocality attribute 314 may define a physical location (e.g., a city, state, region, or another geographic area) of a network device or device group that executes H-UPF 204.

The form of an attribute data type that may be used for UPFinfo data type 310 illustrated in FIG. 3B is exemplary. For example, in another implementation only one of PlmnRangeList attribute 312 or UpfLocality attribute 314 may be included in UPFinfo data type 310. The number of attributes, the range of values, and the representation of each attribute may differ in other implementations.

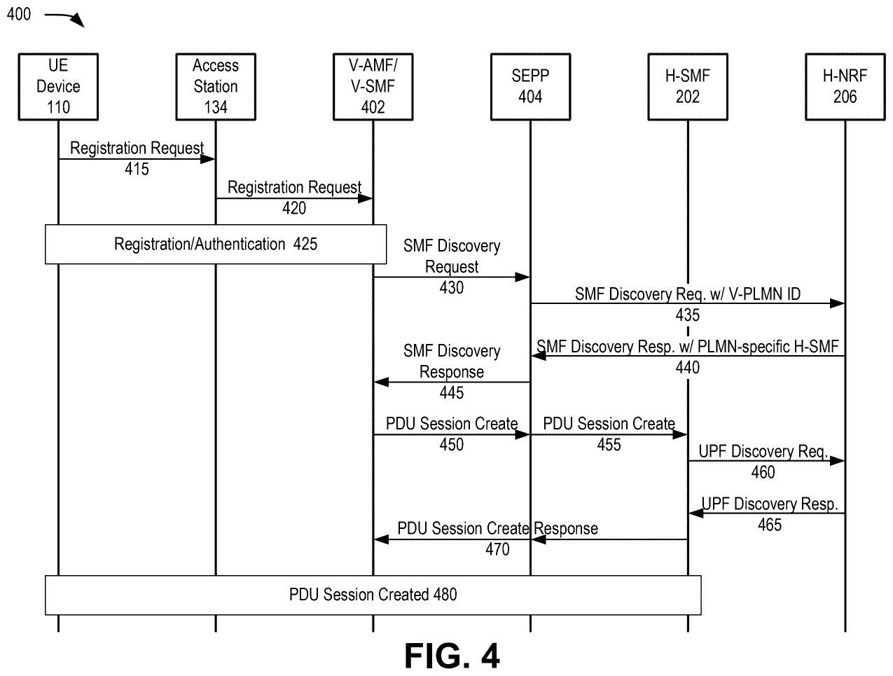

FIG. 4 is a diagram of a portion 400 of network environment 100 including components of networks 120 and 130 for optimized NF selection service for roaming, according to an implementation. As shown in FIG. 4, network portion 400 may include UE device 110, a visited access station 134, H-SMF 202, H-NRF 206, a visited AMF and SMF (V-AMF/V-SMF) 402, and a SEPP 404. Communications in FIG. 4, illustrate communications to select a network function for roaming during, for example, PDU session establishment. FIG. 4 provides simplified illustrations of communications in network portion 400 and is not intended to reflect every signal or communication exchanged between devices/functions.

According to an embodiment, H-SMF 202, H-NRF 206, V-AMF/V-SMF 402, and SEPP 404 may each include logic of an aspect of the optimized NF selection service and/or provide support for a process of the optimized NF selection service. For example, H-SMF 202, H-NRF 206, V-AMF/V-SMF 402, and SEPP 404 may each perform a function, an operation, and/or a service that is beyond a function, operation, and/or service associated with the network standard.

V-AMF/V-SMF 402 may be components of visited network 130 and are shown as a combined component in FIG. 4 for simplicity. The V-AMF of V-AMF/V-SMF 402 performs mobility management for the UE devices 110 connecting to visited network 130. For example, the V-AMF discovers a V-SMF and an H-SMF to use for creating a PDU session. The SMF of V-AMF/V-SMF 402 may communicate with the H-SMF, for example, to create the PDU session for UE device 110. SEPP 404 may provide a security and/or internetworking function for home network 120. Control plane messaging between the visited network 130 and home network 120 may include communication via SEPP 404, as illustrated in FIG. 4. For example, SEPP 404 may intercept a message, such as a discovery request, from a V-AMF (e.g., V-AMF/SMF 402) to home network 120. SEPP 404 may generally be co-located with an IPX that receives roaming traffic from, and sends traffic to, visited network 130.

According to an implementation, communications in FIG. 4 relate to UE device 110 and a home-routed roaming context. For example, as described further below and elsewhere, home-routed roaming may include UE device 110 registering and authenticating with a core network (e.g., V-AMF/SMF 402) of visited network 130. Control plane messaging between the visited core network and a home core network may include communications via SEPP 404, as illustrated in FIG. 4. Although not illustrated, upstream user plane traffic may traverse the visited core network (e.g., a V-UPF or the like (not illustrated)) to the home core network (e.g., an H-UPF or the like (not illustrated)) and to a data network (e.g., data network 150) or other type of end device application layer network (not illustrated), and/or downstream user plane traffic may traverse in the opposite direction along the same path, for example. The messages described and illustrated are exemplary. Additionally, some messages that may occur to establish a PDU session have been omitted for the sake of brevity.

Referring to FIG. 4, although not illustrated, UE device 110 may establish a radio resource connection (RRC) with visited access station 134. Thereafter, UE device 110 may generate and transmit a registration request 415 to access station 134. Access station 134 may receive and analyze registration request 415, and, in response, generate and transmit a registration request 420 to V-AMF/V-SMF 402. In response to receiving and reading and/or analyzing registration request 420, V-AMF/V-SMF 402 and UE device 110 may perform a registration and authentication procedure 425. Although not illustrated, the procedure may include inter-device communications and/or communications with other visited network devices 132, which have been omitted for the sake of brevity.

According to an implementation, after successful completion of the registration and authentication procedure 425, UE device 110 and V-AMF/V-SMF 402 may perform a PDU session creation procedure. For example, although not illustrated, UE device 110 may generate and transmit a PDU Session Create Request message to V-AMF/V-SMF 402. The PDU Session Create Request message may include a Subscription Permanent Identifier (SUPI), a Data Network Name (DNN), Single-Network Slice Selection Assistance information (S-NSSAI(s)), a PDU Session Identifier, an AMF identifier, a Request Type, User location information, and other information of such message in accordance with a 3GPP or other governing body standard.

Responsive to or as a part of the PDU session creation procedure, V-AMF/V-SMF 402 may generate and transmit an SMF discovery request 430 to SEPP 404. SMF discovery request 430 may include data requesting a home SMF, such as data including a PLMN ID of visited network 130. According to an implementation, the PLMN ID may be included as an information element in SMF discovery request 430.

In response to receiving and reading and/or analyzing SMF discovery request 430, SEPP 404 may serve as a NF consumer and initiate an SMF discovery query procedure with H-NRF 206. For example, SEPP 204 may generate and transmit an SMF discovery request 435 to H-NRF 206. SMF discovery request 435 may include data indicating the type of network function requested (e.g., an SMF of the home network). SMF discovery request 435 may also include other data, such as the PLMN ID of visited network 130, an identifier of UE device 110, and so forth.

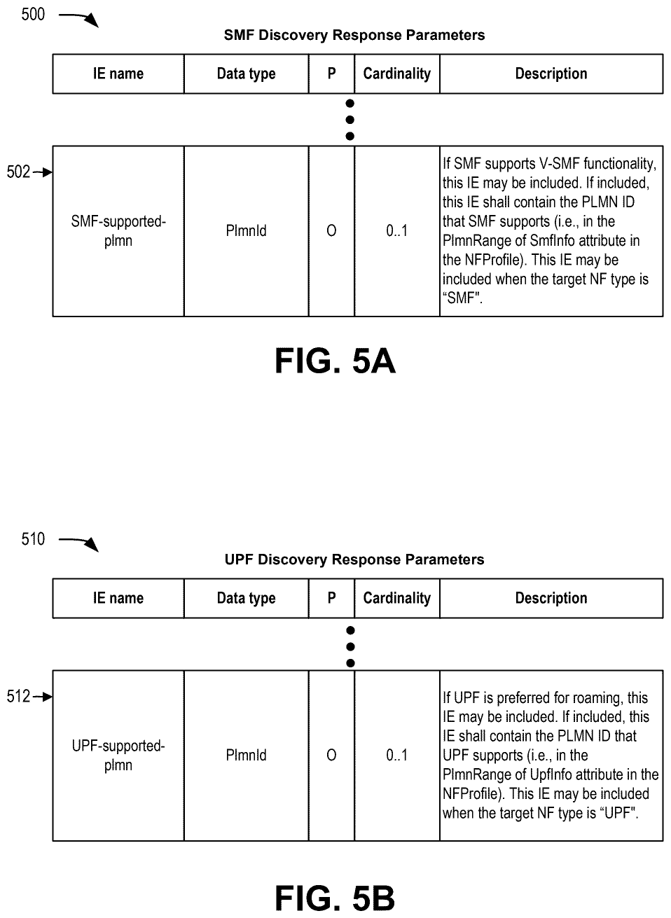

FIG. 5A is a diagram illustrating parameters of a new information element (IE), SMF-supported-PLMN IE 502, for SMF discovery response parameters 500, which may be used in SMF discovery request 430 and/or in SMF discovery request 435, as described above. According to an implementation, the parameters for SMF discovery parameters 500 may be defined in a structured data type according to a format for wireless network standards, such as a 3GPP standard, or another schema. SMF discovery parameters 500 may include a list of information elements, with each information element including an attribute name, a data type, a presence indicator, a cardinality indicator, and a description. According to implementations described herein, a new IE, SMF-supported-PLMN IE 502, may be added to a set of previously-known IEs for SMF discovery parameters 500. SMF-supported-PLMN IE 502 may define attributes for what PLMN(s) need to be supported by a particular H-SMF 202. For example, SMF-supported-PLMN IE 502 may define a PLMN of the visiting network 130 which is providing roaming service to UE device 110.

The form of SMF-supported-PLMN IE 502 illustrated in FIG. 5A is exemplary. The number of attributes, the range of values, and the representation of each attribute may differ in other implementations.

Returning to FIG. 4, in response to receiving, reading, and/or analyzing SMF discovery request 435, H-NRF 206 may perform a lookup, identify the appropriate SMF, and provide indications or information pertaining to the requested type of network function (e.g., an SMF, such as H-SMF 202) to SEPP 404 in a discovery response 440. H-NRF 206 may select or identify H-SMF 202 as the appropriate SMF based on the selected PLMN ID indicated in SMF discovery request 435 and the previously registered PlmnRangeList attribute 302.

In response to receiving SMF discovery response 440, SEPP 404 may generate and transmit an SMF discovery response 445 to V-AMF/V-SMF 402. SMF discovery response 445 may include data indicating or identifying H-SMF 208.

In response to receiving and reading and/or analyzing SMF discovery response 445, V-AMF/V-SMF 402 may generate and transmit a PDU session create request 450 to H-SMF 202 via SEPP 404. PDU session create request 450 may include a requested DNN and visited PLMN ID, for example, among other instances of data.

In response to receiving, reading, and/or analyzing PDU session create request 450, SEPP 404 may generate and transmit a PDU session create request 455 to H-SMF 202. PDU session create request 455 may include PDU session create request 450, in whole or in part. According to an implementation, PDU session create request 455 may also include a locality of SEPP 404, such as a city, state, region, or another geographic area of the SEPP 404. In one embodiment, the locality of SEPP 404 may be included in a header (e.g., a TCP/IP packet header) generated by SEPP 404 when forwarding PDU session create request 450. For example, an N16a interface may be modified to incorporate transmission of the SEPP locality data.

In response to receiving, reading, and/or analyzing PDU session create request 455, H-SMF 202 may serve as a NF consumer and initiate a UPF discovery query procedure with H-NRF 206. For example, SEPP 404 may generate and transmit an UPF discovery request 460 to H-NRF 206. UPF discovery request 460 may include data indicating the type of network function requested (e.g., a UPF of the home network). UPF discovery request 460 may also include other data, such as the PLMN ID of visited network 130, an identifier of UE device 110, and so forth.

FIG. 5B is a diagram illustrating parameters of a new IE, UPF-supported-PLMN IE 512, for UPF discovery response parameters 510, which may be used in UPF discovery request 460, as described above. According to an implementation, the parameters for UPF discovery parameters 510 may be defined in a structured data type according to a format for wireless network standards, such as a 3GPP standard, or another schema. UPF-supported-PLMN IE 512 may include a list of information elements, with each information element including an attribute name, a data type, a presence indicator, a cardinality indicator, and a description. According to implementations described herein, a new IE, UPF-supported-PLMN IE 512, may be added to a set of previously-known IEs for UPF discovery parameters 510. UPF-supported-PLMN IE 512 may define attributes for what PLMN(s) need to be supported by a particular H-UPF 204. For example, UPF-supported-PLMN IE 512 may define a PLMN of the visiting network 130 which is providing roaming service to UE device 110.

The form of UPF-supported-PLMN IE 512 illustrated in FIG. 5B is exemplary. The number of attributes, the range of values, and the representation of each attribute may differ in other implementations.

Returning to FIG. 4, in response to receiving and reading and/or analyzing UPF discovery request 460, H-NRF 206 may perform a lookup, identify an appropriate UPF, and provide indications or information pertaining to the requested type of network function (e.g., a UPF, such as H-UPF 204) to H-SMF 202 in a UPF discovery response 465. H-NRF 206 may select or identify H-UPF 204 as the appropriate UPF based on, for example, the selected PLMN ID indicated in UPF discovery request 460 and the previously registered PlmnRangeList attribute 312. In some implementations, H-NRF 206 may select or identify H-UPF 204 as the appropriate UPF based on SEPP locality information indicated in UPF discovery request 460 and the previously registered locality data attribute 314.

In response to receiving, reading, and/or analyzing PDU session create request 455, H-SMF 202 may generate and transmit a PDU session create response 470 to V-AMF/V-SMF 402 via SEPP 404. PDU session create response 470 may identify the topologically or geographically closest and/or PLMN-restricted H-UPF 204 for UE device 110. As illustrated, a PDU session 480 may be created between UE device 110 and network devices of the visited network and the home network, such as V-AMF/V-SMF 402, H-SMF 202, etc. Thus, communications in FIG. 4 may enable optimized NF selection for SMFs and UPFs of home network 120 in a home-routed roaming context pertaining to UE device 110.

FIG. 4 illustrates an exemplary process of an embodiment of the optimized NF selection service for roaming, however, according to other exemplary embodiments, communications in FIG. 4 may include additional, different, or fewer operations and/or messages than those illustrated and described. For example, according to another exemplary embodiment, the optimized NF selection service for a UPF may be based on only PLMN restrictions or a topologically closest H-UPF 204.

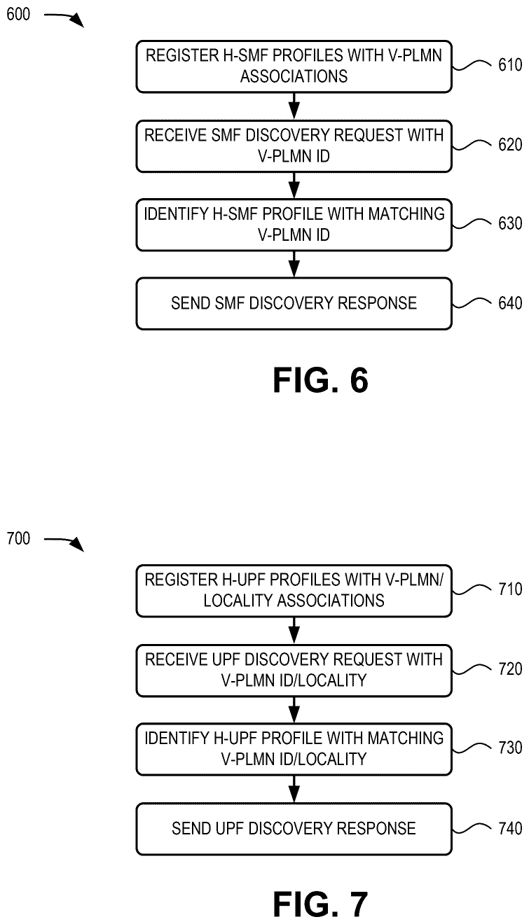

FIG. 6 is a process flow 600 illustrating exemplary operations to provide an optimized NF selection service for roaming. More particularly, process flow 600 provides exemplary operations for selection of an H-SMF for a particular V-PLMN. In one implementation, the operations of process flow 600 may be performed by H-NRF 206. In another implementation, some or all of the operations of process flow 600 may be performed by H-NRF 206 in conjunction with one or more other network devices of network environment 100.

Process 600 may include registering H-SMF profiles with V-PLMN associations (block 610). For example, a network administrator may assign H-SMFs 202 to support roaming for one or more V-PLMNs (e.g., under a HR architecture). Each H-SMF 202 may register with H-NRF 206, and H-NRF 206 may store an SMF profile, for each H-SMF 202, that includes the V-PLMN associations (e.g., one or more V-PLMN IDs or other network identifiers). For each registered SMF, H-NRF 206 may store an SMF profile associating the H-SMF 202 with a visited network identifier.

Process 600 may also include receiving an SMF discovery request that includes a V-PLMN ID (block 620). For example, in response to a roaming session initiated by UE device 110, H-NRF 206 may receive from a network consumer (e.g., SEPP 404) an SMF discovery request including a V-PLMN ID of visited network 130.

Process 600 may further include identifying an H-SMF profile with a matching V-PLMN ID (block 630) and sending an SMF discovery response (block 640). For example, in response to the SMF discovery request, H-NRF 206 may perform a lookup to match the V-PLMN ID of the SMF discovery request with a visited network identifier in a stored SMF profile. H-NRF 206 may identify a matching H-SMF 202 and send to the network consumer (e.g., SEPP 404) an SMF discovery response that includes an identifier for a corresponding H-SMF (e.g., a network address for H-SMF 202). Thus, the roaming session can be assigned to an H-SMF that is specifically designated to support the current V-PLMN.

FIG. 7 is a process flow 700 illustrating other exemplary operations to provide an optimized NF selection service for roaming. More particularly, process flow 700 provides exemplary operations for selection of a H-UPF for a particular V-PLMN or IPX. In one implementation, the operations of process flow 600 may be performed by H-NRF 206. In another implementation, some or all of the operations of process flow 600 may be performed by H-NRF 206 in conjunction with one or more other network devices of network environment 100.

Process 700 may include registering H-UPF profiles with V-PLMN associations and/or locality associations (block 710). For example, a network administrator may assign different H-UPFs 204 to support roaming for one or more V-PLMNs (e.g., under a HR architecture). Additionally, or alternatively, each H-UPF 204 may also be designated with a locality (e.g., a city, state, region, etc.). Each H-UPF 204 may register with H-NRF 206, and H-NRF 206 may store a UPF profile, for each H-UPF 204, that includes the V-PLMN associations and/or the locality association.

Process 700 may also include receiving a UPF discovery request that includes a V-PLMN ID (block 720). For example, in response to a session creation message from SEPP 404, H-NRF 206 may receive from a network consumer (e.g., H-SMF 202) a UPF discovery request including a V-PLMN ID of visited network 130 and a locality of the SEPP 404. For example, the locality of SEPP 404 may be appended in a header that SEPP 404 attaches when forwarding a session creation message originated by V-AMF/V-SMF 402.

Process 700 may further include identifying a UPF profile with a matching V-PLMN ID and/or locality ID (block 730) and sending a UPF discovery response (block 740). For example, in one implementation, in response to the UPF discovery request, H-NRF 206 may perform a lookup to match the V-PLMN ID of the UPF discovery request with a visited network identifier in a stored UPF profile. In another implementation, H-NRF 206 may perform a lookup to match the locality ID of the UPF discovery request with a locality in a stored UPF profile. H-NRF 206 may identify a matching H-UPF 202 (e.g., based on the V-PLMN ID and/or locality) and send to the network consumer (e.g., H-SMF 206) a UPF discovery response that includes an identifier for a corresponding H-UPF (e.g., a network address for H-UPF 204). Thus, the roaming session can be assigned to an H-UPF that is specifically designated to support the current V-PLMN and/or is topologically closest to the IPX for visited network 130.

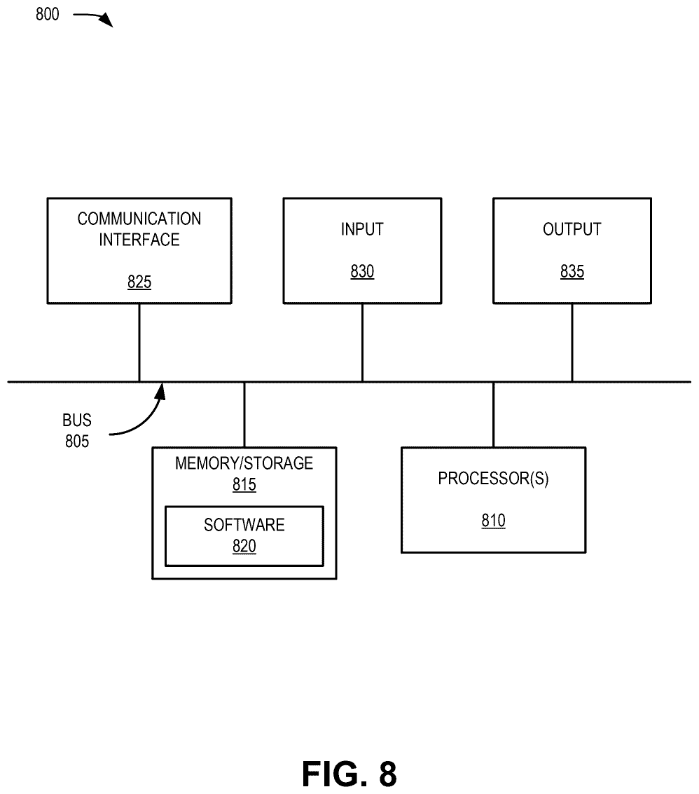

FIG. 8 is a diagram illustrating exemplary components of a device 800 that may correspond to one or more of the devices described herein. For example, device 800 may correspond to components included in UE devices 110, home network 120, visited network 130, and/or other elements illustrated in FIGS. 1, 2, and 4. As illustrated in FIG. 8, according to an exemplary embodiment, device 800 includes a bus 805, one or more processors 810, memory/storage 815 that stores software 820, a communication interface 825, an input 830, and an output 835. According to other embodiments, device 800 may include fewer components, additional components, different components, and/or a different arrangement of components than those illustrated in FIG. 8 and described herein.

Bus 805 includes a path that permits communication among the components of device 800. For example, bus 805 may include a system bus, an address bus, a data bus, and/or a control bus. Bus 805 may also include bus drivers, bus arbiters, bus interfaces, and/or clocks.

Processor 810 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 810 may be implemented as hardware (e.g., a microprocessor, etc.), a combination of hardware and software (e.g., a SoC, an ASIC, etc.), may include one or multiple memories (e.g., cache, etc.), etc. Processor 810 may be a dedicated component or a non-dedicated component (e.g., a shared resource).

Processor 810 may control the overall operation or a portion of operation(s) performed by device 800. Processor 810 may perform one or multiple operations based on an operating system and/or various applications or computer programs (e.g., software 820). Processor 810 may access instructions from memory/storage 815, from other components of device 800, and/or from a source external to device 800 (e.g., a network, another device, etc.). Processor 810 may perform an operation and/or a process based on various techniques including, for example, multithreading, parallel processing, pipelining, interleaving, etc.

Memory/storage 815 includes one or multiple memories and/or one or multiple other types of storage mediums. For example, memory/storage 815 may include one or multiple types of memories, such as, random access memory (RAM), dynamic random-access memory (DRAM), cache, read only memory (ROM), a programmable read only memory (PROM), a static random-access memory (SRAM), a single in-line memory module (SIMM), a dual in-line memory module (DIMM), a flash memory (e.g., a NAND flash, a NOR flash, etc.), and/or some other type of memory. Memory/storage 815 may include a hard disk (e.g., a magnetic disk, an optical disk, a magneto-optic disk, a solid-state disk, etc.), a Micro-Electromechanical System (MEMS)-based storage medium, and/or a nanotechnology-based storage medium. Memory/storage 815 may store data, software, and/or instructions related to the operation of device 800.

Software 820 includes an application or a program that provides a function and/or a process. Software 820 may include an operating system. Software 820 is also intended to include firmware, middleware, microcode, hardware description language (HDL), and/or other forms of instruction.

Communication interface 825 permits device 800 to communicate with other devices, networks, systems, devices, and/or the like. Communication interface 825 includes one or multiple wireless interfaces and/or wired interfaces. For example, communication interface 825 may include one or multiple transmitters and receivers, or transceivers (e.g., radio frequency transceivers). Communication interface 825 may include one or more antennas. For example, communication interface 825 may include an array of antennas. Communication interface 825 may operate according to a protocol stack and a communication standard. Communication interface 825 may include various processing logic or circuitry (e.g., multiplexing/de-multiplexing, filtering, amplifying, converting, error correction, etc.).

Input 830 permits an input into device 800. For example, input 830 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 835 permits an output from device 800. For example, output 835 may include a speaker, a display, a light, an output port, and/or some other type of visual, auditory, tactile, etc., output component. According to some embodiments, input 830 and/or output 835 may be a device that is attachable to and removable from device 800.

Device 800 may perform a process and/or a function, as described herein, in response to processor 810 executing software 820 stored by memory/storage 815. By way of example, instructions may be read into memory/storage 815 from another memory/storage 815 (not shown) or read from another device (not shown) via communication interface 825. The instructions stored by memory/storage 815 cause processor 810 to perform a process described herein. Alternatively, for example, according to other implementations, device 800 performs a process described herein based on the execution of hardware (processor 810, etc.).

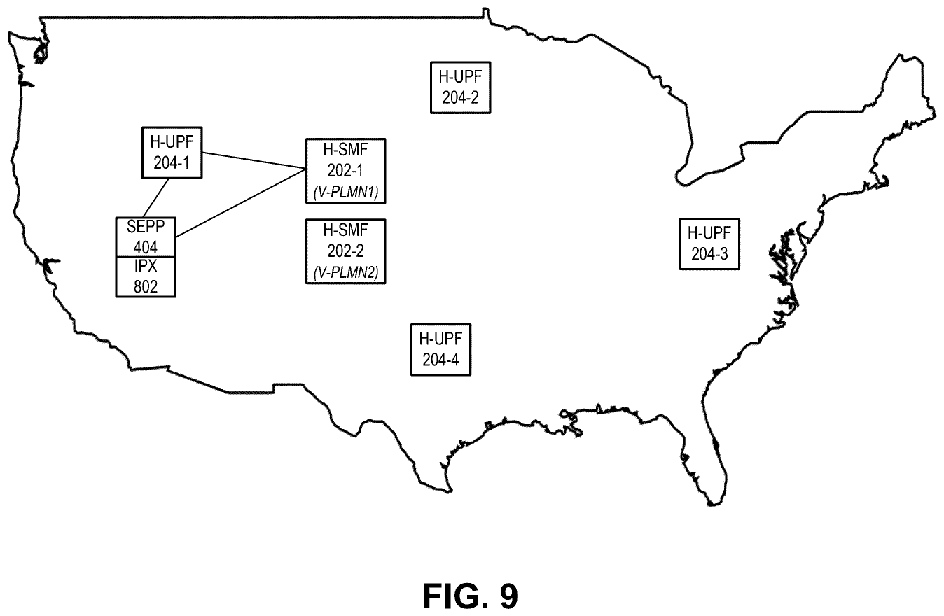

FIG. 9 illustrates a use case of the optimized NF selection service for roaming, according to an implementation. More particularly, FIG. 9 illustrates a use case where a UE device (not shown) is roaming on a visited network (referred to as V-PLMN1) that uses IPX 802 co-located with SEPP 404 to facilitate HR roaming with the UE device's home network. H-SMF 202-1 is the designated SMF for V-PLMN1 and H-SMF 202-2 is a designated SMF for another network (e.g., V-PLMN2). Further, assume each of H-UPF 204-1, 204-2, 204-3, and 204-4 are designated UPFs for V-PLMN1 and are assigned to a locality. Assume that the various H-SMFs 202 and H-UPFs 204 have profiles registered with an H-NRF (not shown).

SEPP 404 forwards to the H-NEF a SMF discovery request with the PLMN ID for V-PLMN-1. The H-NEF will assign H-SMF 202-1 for the roaming session (in lieu of H-SMF 202-2), based on the stored SMF profile and designated assignment tor V-PLMN1. Since each of the H-UPFs 204 are designated UPFs for V-PLMN1, when H-SMF 202-1 later submits a UPF discovery request, the H-NEF will assign H-UPF 204-1 as the topologically closest UPF that is designated to support V-PLMN1. Thus, a V-PLMN-specific H-SMF may be assigned for the UE device's roaming session on V-PLMN1. Furthermore, the topologically closest H-UPF that is designated for use with V-PLMN1 may be efficiently assigned.

As described herein, a method, a device, and a non-transitory storage medium provide an optimized NF selection service for roaming. In one implementation, a home SMF may be designated to serve to one or more specific visited PLMNs. A first network device (e.g., an NRF) in a home network receives, from a second network device (e.g., a SEPP), a first discovery message, the first discovery message including a visited network identifier of a visited network for a roaming session. The first network device matches the visited network identifier to a network identifier in a stored SMF profile. The first network device sends, to the second network device, a first identifier for a home SMF for the roaming session based on the visited network identifier.

The foregoing description of embodiments provides illustrations but is not intended to be exhaustive or to limit the embodiments to the precise form disclosed. In the preceding description, various embodiments have been described with reference to the accompanying drawings. However, various modifications and changes may be made thereto, and additional embodiments may be implemented, without departing from the broader scope of the invention as set forth in the claims that follow. The description and drawings are accordingly to be regarded as illustrative rather than restrictive.

In addition, while series of blocks have been described with regard to the processes illustrated in FIGS. 6 and 7, and series of signals with respect to FIGS. 2 and 4, the order of the blocks and/or signals may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware. For example, a process or a function may be implemented as “logic” or as a “component.” The logic or the component may include, for example, hardware (e.g., processor 810, etc.), or a combination of hardware and software. The embodiments have been described without reference to the specific software code since the software code can be designed to implement the embodiments based on the description herein and commercially available software design environments/languages.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 810) of a computational device. A non-transitory storage medium includes one or more of the storage mediums described in relation to memory 815.

To the extent the aforementioned embodiments collect, store or employ personal information provided by individuals, or any other user data or subscription data, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

1. A method, comprising:
receiving, by a first network device in a home network and from a second network device, a first discovery message, the first discovery message including a visited network identifier for a roaming session;
matching the visited network identifier to a network identifier in a Session Management Function (SMF) profile; and
sending, by the first network device and to the second network device, a first identifier for a home SMF (H-SMF) for the roaming session based on the visited network identifier.

2. The method of claim 1, further comprising:
receiving, by the first network device, a registration message from the H-SMF, the registration message associating the H-SMF with the visited network identifier; and
storing, in a memory, an SMF profile associating the H-SMF with the visited network identifier.

3. The method of claim 1, further comprising:
receiving, by the first network device and from the H-SMF, a second discovery message, the second discovery message including the visited network identifier;
matching the visited network identifier to a network identifier in a User Plane Function (UPF) profile; and
sending, by the first network device and to the H-SMF, a second identifier for a home UPF (H-UPF) for the roaming session based on the visited network identifier.

4. The method of claim 3, further comprising:
receiving, by the first network device, a registration message from the H-UPF, the registration message associating the H-UPF with the visited network identifier; and
storing, in a memory, a UPF profile associating the H-UPF with the visited network identifier.

5. The method of claim 4, further comprising:
receiving, by the first network device and from the H-SMF, a locality identifier of the second network device,
wherein sending the second identifier for the H-UPF is further based on the locality identifier.

6. The method of claim 5, further comprising:
receiving, by the first network device, a registration message from the H-UPF, the registration message associating the H-UPF with the locality identifier; and
storing, in a memory, the UPF profile associating the H-UPF with the locality identifier.

7. The method of claim 1, wherein the first network device includes a Network Repository Function (NRF) for the home network.

8. The method of claim 1, wherein the second network device includes a Security Edge Protection Proxy (SEPP).

9. The method of claim 1, wherein the visited network identifier includes a Public Land Mobile Network (PLMN) identifier.

10. One or more network devices, comprising:
one or more processors configured to execute instructions to:
receive, in a home network and from a second network device, a first discovery message, the first discovery message including a visited network identifier for a roaming session;
match the visited network identifier to a network identifier in a Session Management Function (SMF) profile; and
send, to the second network device, a first identifier for a home SMF (H-SMF) for the roaming session based on the visited network identifier.

11. The one or more network devices of claim 10, wherein the one or more network devices includes a Network Repository Function (NRF) for the home network.

12. The one or more network devices of claim 10, wherein the one or more processors is further to execute instructions to:
receive a registration message from the H-SMF, the registration message associating the H-SMF with the visited network identifier; and
store, in a memory, an SMF profile associating the H-SMF with the visited network identifier.

13. The one or more network devices of claim 10, wherein the one or more processors is further to execute instructions to:
receive, from the H-SMF, a second discovery message, the second discovery message including the visited network identifier;
match the visited network identifier to a network identifier in a User Plane Function (UPF) profile; and
send, to the H-SMF, a second identifier for a home UPF (H-UPF) for the roaming session based on the visited network identifier.

14. The one or more network devices of claim 13, wherein the one or more processors is further to execute instructions to:
receive, from the H-SMF, a locality identifier of the second network device,
wherein the one or more processors is further to execute instructions to send the second identifier for the H-UPF is based on the locality identifier and the visited network identifier.

15. The one or more network devices of claim 14, wherein the one or more processors is further to execute instructions to:
receive a registration message from the H-UPF, the registration message associating the H-UPF with the locality identifier.

16. The one or more network devices of claim 10, wherein the second network device includes a Security Edge Protection Proxy (SEPP).

17. A non-transitory computer-readable medium containing instructions executable by at least one processor of a device, the non-transitory computer-readable medium comprising one or more instructions for:
receiving, in a home network and from a second network device, a first discovery message, the first discovery message including a visited network identifier for a roaming session;
matching the visited network identifier to a network identifier in a Session Management Function (SMF) profile; and
sending, to the second network device, a first identifier for a home SMF (H-SMF) for the roaming session based on the visited network identifier.

18. The non-transitory computer-readable medium of claim 17, further comprising one or more instructions for:
receiving a registration message from the H-SMF, the registration message associating the H-SMF with the visited network identifier.

19. The non-transitory computer-readable medium of claim 17, further comprising one or more instructions for:
receiving, from the H-SMF, a second discovery message, the second discovery message including a first locality indicator of the second network device;
matching the first locality indicator to a second locality indicator in a User Plane Function (UPF) profile; and
sending, to the H-SMF, a second identifier for a home UPF (H-UPF) for the roaming session based on the matching.

20. The non-transitory computer-readable medium of claim 19, further comprising one or more instructions for:
receiving a registration message from the H-UPF, the registration message associating the H-UPF with the second locality identifier; and
storing, in a memory, the UPF profile associating the H-UPF with the second locality identifier.
